(19) United States
(12) Patent Application Publication
(10) Pub. No.: US 2002/0070606 A1
(43) Pub. Date: Jun. 13, 2002

(54) CRAWLER LINK SLIDE

(76) Inventor: Rainer Poetter, North Prairie, WI (US)

Correspondence Address: Daniel G. Radler, Quarles & Brady LLP, Suite 2040, 411 East Wisconsin Ave., Milwaukee, WI, 53202-4497, US

(21) Appl. No.: 09/733,297

(22) Filed: Dec. 7, 2000

(51) Int. Cl. B62D 55/104

(52) U.S. Cl. 305/127

(57) ABSTRACT

A crawler link slide suitable for mounting on a projection extending from a crawler frame. The crawler link slide includes a slide body having an upper surface engageable with a crawler belt and a lower surface engageable with a projection extending from a crawler frame. A hook extending from the slide body is engageable with the projection, and limits movement of the slide body relative to the projection in an upwardly and first direction of travel of the crawler belt over the slide body.

### FIELD OF INVENTION

This present invention relates to a crawler assembly having a ground engaging crawler belt, and more particularly to a crawler link slide supporting the crawler belt.

### BACKGROUND OF THE INVENTION

Large excavating equipment, such as a mining shovel, drag line, and the like, are movable on crawler belts. Each belt engages rotatable drive tumbler which drive the belt around a crawler frame to move the excavating equipment. The drive tumbler has teeth which engage the belt, and transfer torque from the tumbler to the belt. The belt is formed from a plurality of crawler links joined together.

The belt is slidably supported above the crawler frame by slides, or guide rails, fixed to the frame. As the belt slides over the slides, the belt links strike the slides and exert horizontal (in the direction of belt travel) and vertical (lifting) forces on each slide which can break the slide away from the crawler frame. In order to counteract these forces, the slides are typically welded to the frame. After continued use, however, the slides become worn and must be replaced. Replacement of the welded on slides is time consuming and expensive.

A pin connected slide is disclosed in Fleuchaus (U.S. Pat. No. 5,941,326) which simplifies slide replacement. However, the slide in Fleuchaus requires a foot which slips into a receptacle formed in a projection extending from the crawler frame. The foot and receptacle combination complicates the fabrication of the slide and projection. Moreover, the slide and projection assembly disclosed in Fleuchaus does not provide any mechanism to compensate for any lifting forces exerted on the slide by the belt other than the pins which are susceptible to breaking.

Impact forces imparted onto the slides by the belt links causes the slides to become set or jammed onto the projections. Slides which are jammed onto the projections are difficult to remove which increases the difficulty to replace worn out slides. Therefore, a need exists for a slide assembly including a slide and projection in which the slide can be easily separated from the projection.

### BRIEF SUMMARY OF THE INVENTION

The present invention provides a crawler link slide suitable for mounting on a projection extending from a crawler frame. The crawler link slide includes a slide body having an upper surface engageable with a crawler belt and a lower surface engageable with a projection extending from a crawler frame. A hook formed on one end of the slide body is engageable with one end of the projection, and limits movement of the slide body relative to the projection in an upwardly and first direction of travel of the crawler belt over the slide body. An inwardly facing surface extending downwardly from the slide body is formed on an opposing end of the slide body. The inwardly facing surface is engageable with the projection to limit movement of the slide relative to the projection in a second direction of travel of the crawler belt over the slide.

A general objective of the present invention is to provide a detachable crawler link slide mountable on a projection which transfers lifting forces to the projection. This objective is accomplished by providing a hook which counteracts lifting forces exerted on the slide by a crawler belt.

Another aspect of the present invention provides a crawler link slide assembly which includes a projection and a slide. The projection having a top surface, an outwardly facing front face, and an outwardly facing rear face. The front face defines a first face angle with respect to the top surface, and the rear face defines a second face angle with respect to the top surface. The slide includes a lower surface, an inwardly facing front surface, and an inwardly facing rear surface. The front surface defines a third face angle with respect to the lower surface and engages the projection front face to define a first interface angle, and the rear surface defines a fourth face angle with respect to the lower surface and engages the projection rear face to define a second interface angle. The first interface angle is not equal to the second interface angle to produce a wedging effect. Advantageously, the wedging effect urges the slide off of the projection when separation of the slide from the projection is desired.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a perspective view of a crawler assembly incorporating the present invention;

FIG. 2 is a side view of the crawler assembly of FIG. 1;

FIG. 3 is a sectional view along line 3-3 of FIG. 2;

FIG. 4 is a detailed view along line 4-4 of FIG. 3; and

FIG. 5 is a sectional view of a the crawler link slide of FIG. 1;

FIG. 6 is a detailed sectional view of FIG. 1;

FIG. 6A is a view of the slide not fully seated on the projection of FIG. 6; and

FIG. 7 is a perspective view of the slide of FIG. 1.

### DETAILED DESCRIPTION OF THE PREFERRED EMBODIMENT

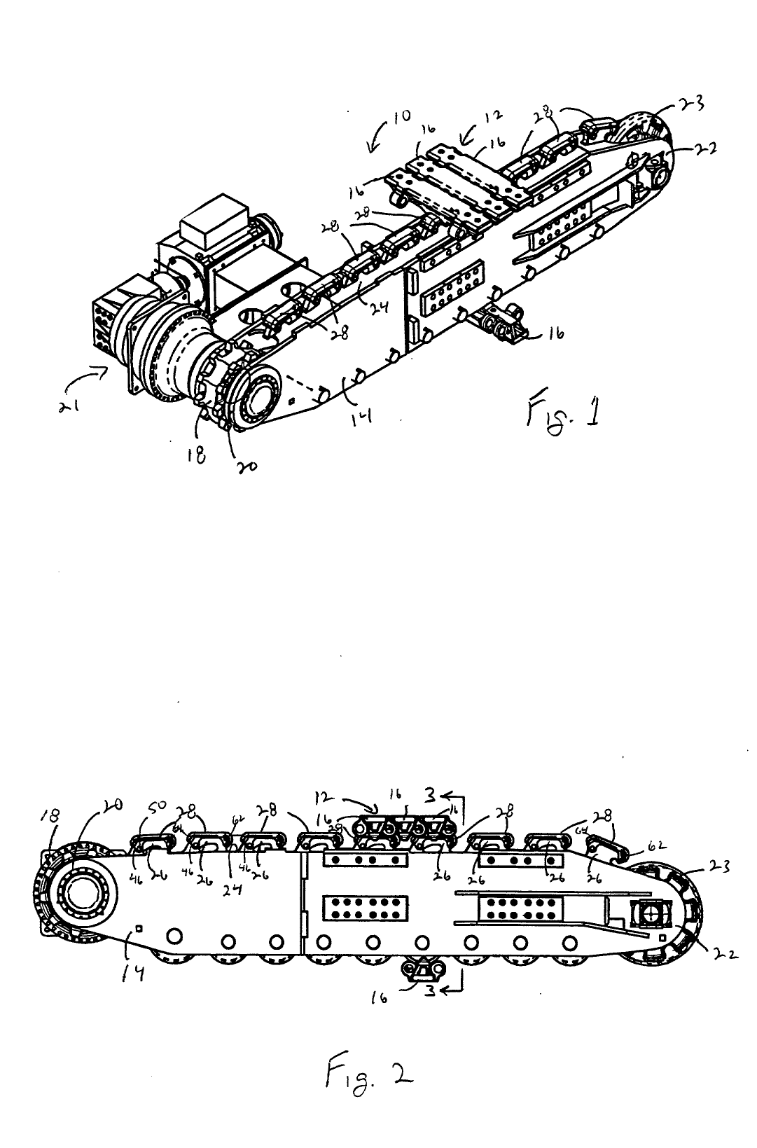

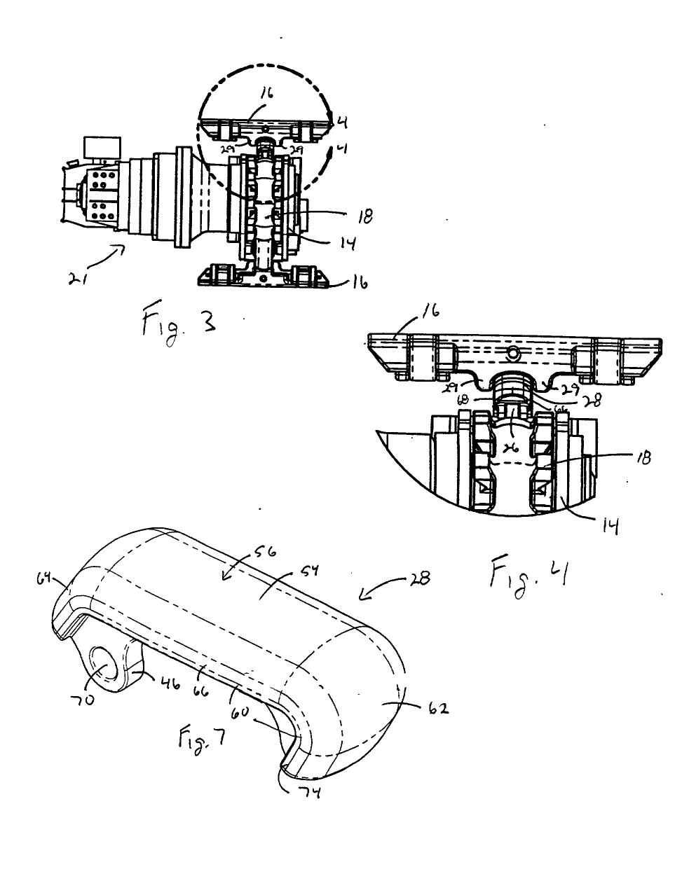

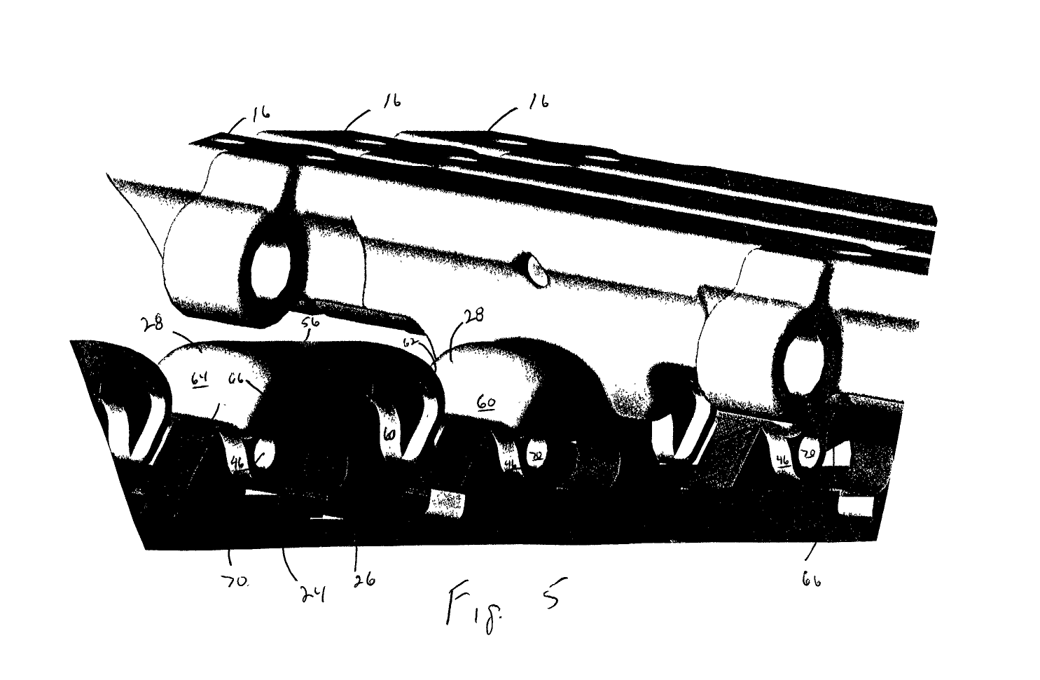

As shown in FIGS. 1-4, a crawler assembly 10 includes a crawler belt 12 wrapped around a crawler frame 14. The crawler belt 12 is formed from a plurality of links 16, and driven around the frame by a drive tumbler 18 rotatably mounted at one end 20 of the frame 14. A drive mechanism 21 bidirectionally drives the drive tumbler 18 which urges the belt 12 longitudinally around the frame 14 to move the crawler assembly 10 in a forwardly or rearwardly direction.

The crawler frame 14 includes the one end 20 on which the drive tumbler 18 is mounted and an opposing end 22 over which the belt 12 slides. A guide wheel 23 rotatably mounted on the opposing end 22 smoothly transitions the belt 12 around the end 22. A top plate 24 joins the frame ends 20, 22, and supports projections 26 extending away from the frame 14. The projections 26 are fixed to the top plate 24, such as by welding, and support crawler link slides 28 which slidably support the crawler belt 16.

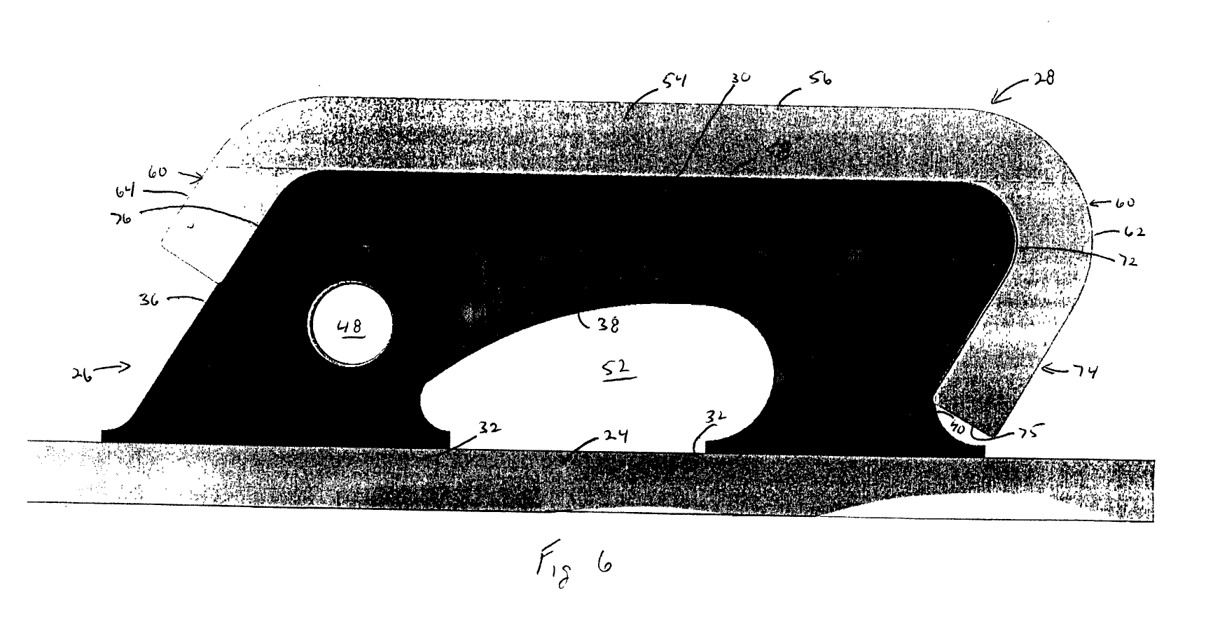

Referring to FIGS. 4-7, each projection 26 supports a single slide 28, and includes a top surface 30, a bottom surface 32 fixed to the top plate 24, a front face 34, a rear face 36, all of which are joined by sides 38. Preferably the front face and rear face define oblique angles relative to the top surface. Most preferably, for reasons explained below, the angle A defined by the front face is different from the angle B defined by the rear face.

A recess 40 formed in the front face 34 proximal the bottom surface 32 engages a hook 42 formed as an integral part of the slide 28. The rearwardly facing rear face 36 includes a rearwardly facing surface 44 which engages a skirt 60 formed as an integral part of the slide 28. A hole 48 extending between the sides 38 receives a pin 50 (shown in FIG. 2) which locks the slide 28 onto the projection 26. A cutout 52 can be formed in the projection 26 to reduce the projection weight.

Each slide is detachably fixed to one of the projections 26, and slidably-engages the crawler belt links 16 above the frame 14. Preferably, each slide 28 includes a slide body 54 and a skirt 60 having sides 66, 68. The slide body includes an upper surface 56 engageable with the crawler belt links 16 and a downwardly facing lower surface 58 engageable with the projection 16. Lugs 46 extend downwardly from each skirt side 66, 68, and include a hole 70 aligned with the hole 48 formed in the projection 26.

The skirt 60 extends downwardly from the body 54 around the projection 26, and has opposing ends 62, 64 joined by the sides 66, 68. Preferably, the skirt sides 66, 68 extend downwardly at least a distance sufficient to prevent lateral movement of the slide 28 on the projection 26. Although a full skirt extending downwardly from the entire periphery edge of the body is preferred, skirt portions forming a partial skirt can be used without departing from the scope of the present invention.

At one skirt end 62, the skirt 60 extends includes an inwardly facing surface 72 which engages the projection front face 34, and a portion of the skirt end 62 extends inwardly to form a hook 74. The skirt inwardly facing surface 72 limits movement of the slide 28 relative to the projection 26 in one direction of travel of the crawler belt 12, such as a rearwardly direction, over the slide 28.

The hook 74 includes a hook end 75 which wraps around the projection front face 34 beneath the projection top surface 30, and into the front face recess 40 to engage the hook 74 with the projection 26. Advantageously, engaging the hook 74 with the projection 26 counteracts lifting forces exerted on the slide by the belt links 16 striking the slide 26 as the belt 12 slides over the slide 28 . Although a hook 74 formed at one skirt end 62 is preferred, the hook 74 can be formed anywhere along the skirt 60 or as a separate appendage to the body 54 without departing from the scope of the present invention.

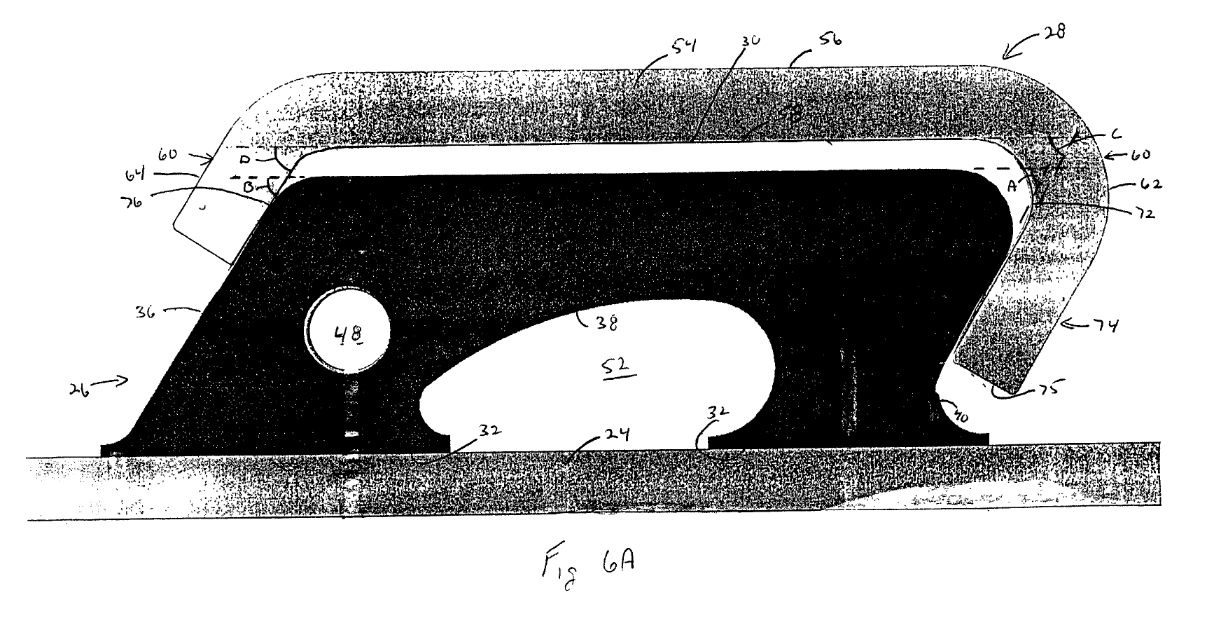

As shown in FIG. 6, at the other skirt end 64, an inwardly facing surface 76 engages the projection rear face 36 to limit movement of the slide 28 relative to the projection 26 in a second direction of belt travel, such as a forwardly direction, over the slide 26. Preferably, the one direction of belt travel is opposite from said second direction of belt travel.

Referring to FIG. 6A, the inwardly facing skirt surfaces 72, 76 are formed to define different angles C, D relative to the slide lower surface 58 to provide a wedging effect in cooperation with the corresponding projection faces 34, 36 which define different angles A, B with the projection top surface 30. The wedging effect simplifies subsequent separation of the slide 28 from the projection 26 after the slide 28 has been set on the projection 26 by constant impacts from the crawler belt links 16.

Preferably, the wedging effect is accomplished by providing a projection having a top surface 30 having a length greater than the length of the slide lower surface, and substantially matching the angle A, B defined by the each projection face 34, 36 with the angle C, D of the inwardly facing skirt surface 72, 76 engaging the respective projection face 34, 36. In the preferred embodiment, the interface between enagaging surfaces defines an interface angle which is substantially equal to the angle of the projection face 34, 36 and skirt surface 72, 76 of the interface. For example the angle A defined by the projection front face 34 equals angle C defined by the slide skirt inwardly facing front surface 72 to define an interface angle substantially equal to the average of angles A and C. Likewise, angle B defined by the projection rear face 36 equals angle D defined by the slide skirt inwardly facing rear surface 76 to define an interface angle substantially equal to the average of angles B and D.

When the length of the projection top surface 30 is greater than the length of the slide lower surface 58, a different interface angle at each slide skirt and projection interface causes only the skirt surfaces 72, 76 to initially engage the respective projection faces 34, 36. Impacts from the belt links 16 sliding over the slide 28 forces the slide 28 downwardly and compresses the slide skirt surfaces 72, 76 and projection faces 34, 36 of each interface until the slide lower surface 58 engages the projection top surface 30. When separation of the slide 28 from the projection 26 is desired, the compressed surfaces 72, 76 and faces 34, 36 at the interfaces urge the slide 28 off of the projection 26 to simplify removal of the slide by reducing the effort required to detach the slide 28 from the projection 26.

In the embodiment shown in FIG. 7, the projection front face 34 is formed to define an angle of approximately 60° with respect to the top surface 30 of the projection 26, and the slide skirt one end inwardly facing surface 72 is formed to define an angle of approximately 60° with respect to the slide lower surface 58. The interface angle of the interface between the projection front face 34 and the skirt inwardly facing surface 72 is then equal to approximately 60°. The projection rear face 36 is formed to define an angle of approximately 55° with respect to the top surface 30 of the projection 26, and the slide skirt other end inwardly facing surface 76 is formed to define an angle of approximately 55° with respect to the slide lower surface 58. The interface angle of the interface between the projection rear face 36 and the other skirt inwardly facing surface 76 is then equal to approximately 55°.

The 5° difference between the two interface angles provides the desirable wedging effect in a slide 28 having a lower surface 58 of approximately 24 inches in length and the projection top surface 30 has a length which provides a gap of approximately 1/16″ between the lower surface 58 and top surface 30 when the 28 slide is initially placed on the projection 26. Although an interface angle difference of 5° is disclosed, the interface angle difference depends upon the size of the slide and projection, the materials used, and other factors, and therefore can vary without departing from the scope of the present invention.

The slide 28 is detachably fixed relative to the projection 26 by a locking mechanism which locks the slide 28 onto the projection 26. Preferably, the locking mechanism includes the pin 50 extending through the skirt side lug and projection holes 48, 70 to lock the slide 28 onto the projection 26. Although the pin 50 extending through the skirt side lug and projection holes 48, 70 is preferred, other methods of locking the slide 28 on the projection 26 can be used without departing from the scope of the present invention, such as welding, bolting, and the like.

Advantageously, by providing a slide 28 having opposing inwardly facing surfaces 72, 76 formed at each skirt end 62, 64 which engage the projection 26, longitudinal forces exerted on the slide 28 by the sliding belt links 16 are absorbed by the projection 26, and not the pin 50 locking the slide 28 onto the projection 26. In addition, a hook 74 extending from the slide 28 which engages the projection 26 counteracts lifting forces which urge the slide 28 upwardly, and prevent the transfer of the lifting forces to the pin 50.

Referring back to FIGS. 1-4, the crawler belt links are hingedly joined to form an endless crawler belt, and are slidably supported by the slides. Preferably, each link 16 straddles the link slide 28, and has guides 29 which engage the slide 28, and limits lateral movement of the link 16 on the slide 28.

In use, the slide 28 is detachably mounted onto the projection 26 by engaging the hook 74 formed at one skirt end 62 over the projection front face 34, and then lowering the opposing slide skirt end 64 such that the slide body 54 engages the projection 26, and the skirt 60 surrounds the projection 26. The pin 50 is then inserted through the skirt lug holes 70 which are aligned with the hole 48 formed in the projection 26. The slide 28 is detached from the projection 26 by removing the pin 50, and slipping the slide 28 off of the projection 26.

While there has been shown and described what are at present considered the preferred embodiments of the invention, it will be obvious to those skilled in the art that various changes and modifications can be made therein without departing from the scope of the invention defined by the appended claims.

We claim:

1. A crawler link slide suitable for mounting on a projection extending from a crawler frame, said crawler link slide comprising:
a slide body having an upper surface engageable with a crawler belt and a lower surface engageable with a projection extending from a crawler frame;
a hook formed on one end of said slide body engageable with one end of the projection to limit movement of said slide relative to the projection in an upwardly and first direction of travel of the crawler belt over said slide body; and
an inwardly facing surface extending downwardly from said slide body formed on an opposing end of said slide body, and engageable with the projection to limit movement of said slide relative to the projection in a second direction of travel of the crawler belt over said slide, wherein said first direction of travel is opposite from said second direction of travel.

2. The crawler link slide of claim 1, in which a locking mechanism locks said slide onto the projection.

3. The crawler slide of claim 2, in which said locking mechanism includes sides extends downwardly from said body over the projection, and a pin extending through said sides and the projection lock said slide onto the projection.

4. The crawler slide of claim 2, in which said locking mechanism includes welding said slide to said projection.

5. A crawler link slide suitable for mounting on a projection extending from a crawler frame, said crawler link slide comprising:
a slide body having an upper surface engageable with a crawler belt and a lower surface engageable with a projection extending from a crawler frame;
a hook formed on one end of said slide body engageable with one end of the projection to limit movement of said slide relative to the projection in an upwardly and first direction of travel of the crawler belt over said slide body; and
a locking mechanism locks said slide onto the projection.

6. The crawler slide of claim 5, in which said locking mechanism includes sides extends downwardly from said body over the projection, and a pin extending through said sides and the projection lock said slide onto the projection.

7. The crawler slide of claim 5, in which said locking mechanism includes welding said slide to said projection.

8. The crawler link slide of claim 4, in which said slide body includes a downwardly extending portion having a longitudinally projecting face engageable with the projection which prevents movement of said slide relative to the projection in a second direction of travel of the crawler belt over said slide, wherein said first direction of travel is opposite from said second direction of travel.

9. A crawler link slide suitable for mounting on a projection extending from a crawler frame, said crawler link slide comprising:
a slide body having an upwardly facing surface engageable with a crawler belt and a downwardly facing surface engageable with a projection extending from a crawler frame;
a skirt extending downwardly from said body;
a portion of said skirt extending inwardly and engageable with a downwardly facing surface of the projection to prevent movement of said slide body in an upwardly and first direction of travel of the crawler belt over said slide body.

10. The crawler link slide of claim 9 including at least one portion of said skirt having an inwardly projecting face engageable with the projection which prevents movement of said slide relative to the projection in a second direction of travel of the crawler belt over said slide body.

11. A crawler link slide assembly comprising:
a projection having a top surface, an outwardly facing front face, and an outwardly facing rear face, said front face defining a first face angle with respect to said top surface, and said rear face defining a second face angle with respect to said top surface;
a slide having a lower surface, an inwardly facing front surface, and an inwardly facing rear surface, said front surface defining a third face angle with respect to said lower surface and engaging said projection front face to define a first interface angle, and said rear surface defining a fourth face angle with respect to said lower surface and engaging said projection rear face to define a second interface angle, wherein said first interface angle is not equal to said second interface angle to produce a wedging effect.

12. The crawler link slide assembly as in claim 11, in which said first face angle is substantially equal to said third face angle to define said first interface angle substantially equal to said first and third face angles, and said second face angle is substantially equal to said fourth face angle to define said second interface angle substantially equal to said second and fourth face angles.

13. The crawler link slide assembly as in claim 11, including a hook formed on one end of said slide engageable with one end of said projection to limit movement of said slide relative to said projection in an upwardly and first direction of travel of the crawler belt over said slide.

14. The crawler link slide assembly as in claim 11, in which a locking mechanism locks said slide onto the projection.

15. The crawler link slide assembly as in claim 14, in which said locking mechanism includes sides extends downwardly from said slide over said projection, and a pin extending through said sides and the projection lock said slide onto the projection.

16. The crawler link slide assembly as in claim 14, in which said locking mechanism includes welding said slide to said projection.

17. The crawler link slide assembly as in claim 1, in which said top surface has a length which is greater than said lower surface.
